(19) United States
(12) Patent Application Publication
(10) Pub. No.: US 2013/0163777 A1
(43) Pub. Date: Jun. 27, 2013

(54) SOUND OUTPUT DEVICE

(71) Applicants: Shigeru TASHIRO, Toyokawa-shi (JP); Takayuki ITO, Nagoya-shi (JP); Hiroaki UMEMOTO, Neyagawa-shi (JP)

(72) Inventors: Shigeru TASHIRO, Toyokawa-shi (JP); Takayuki ITO, Nagoya-shi (JP); Hiroaki UMEMOTO, Neyagawa-shi (JP)

(21) Appl. No.: 13/717,454

(22) Filed: Dec. 17, 2012

(30) Foreign Application Priority Data
Dec. 26, 2011 (JP) 2011-282598

(51) Int. Cl. G10K 11/175

(52) U.S. Cl. CPC G10K 11/175
USPC 381/73.1

(57) ABSTRACT

A sound output device for masking an operation sound generated by equipment, having: a sound reproducing unit that starts reproducing a masking sound before the operation sound is generated; and a sound output unit that outputs the masking sound reproduced by the sound reproducing unit.

### CROSS-REFERENCE TO RELATED APPLICATION

This application is based on Japanese Patent Application No. 2011-282598 filed on Dec. 26, 2011, the content of which is incorporated herein by reference.

### BACKGROUND OF THE INVENTION

1. Field of the Invention

The present invention relates to a sound output device that outputs a masker (masking sound) for masking noise generated by equipment.

2. Description of Related Art

Conventionally, to deal with noise generated by, for example, an image forming apparatus or suchlike, a so-called “noise reduction technology” for reducing operation sounds themselves is employed. Noise reduction lowers the sound pressure level of operation sounds, but does not completely solve problems of “harshness” and “discomfort” caused by operation sounds.

Aside from the noise reduction technology, there has also been proposed a sound masking technology as a technology to lower noise (to a less perceptible level). Sound masking is a method taking advantage of a phenomenon (sound masking effect) in which perception of a sound at a certain level makes other sounds barely audible, and this method is mainly classified into frequency masking and temporal masking. More specifically, noise is superimposed with a sound (masker or masking sound) mainly similar in frequency band to the noise, so that the noise is made barely audible, thereby reducing harshness and discomfort.

As a conventional sound output device applying the sound masking technology, there is a noise masking device described in Japanese Patent Laid-Open Publication No. 9-193506. This noise masking device is provided in an image forming apparatus or suchlike with a drive mechanism generating a loud sound (noise) during operation, and the noise masking device includes a sound generator for generating a masking sound to mask the loud sound, and a masking sound control unit for controlling the sound generator to generate a masking sound within a frequency range including the main component frequency of the loud sound. The masking sound control unit allows the masking sound to be generated within a frequency range between the lower and upper limits of a critical frequency band for the main component frequency of the loud sound.

However, in the case where a masking sound is generated after noise generation, there is a problem where the user has noise (equipment operation sound) lingering in the ears, resulting in a reduced masking effect.

### SUMMARY OF THE INVENTION

In an embodiment of the present invention, a sound output device for masking an operation sound generated by equipment includes: a sound reproducing unit that starts reproducing a masking sound before the operation sound is generated; and a sound output unit that outputs the masking sound reproduced by the sound reproducing unit.

### BRIEF DESCRIPTION OF THE DRAWINGS

FIG. 1 is a block diagram illustrating the configuration of a sound output device according to an embodiment of the present invention;

FIG. 2 is a graph showing the basic concept of masking;

FIG. 3 is a graph showing a first example of controlling the sound pressure level of a masking sound for the operation of an image forming apparatus;

FIG. 4 is a graph showing the timing of outputting a masking sound and the degree of change in output volume of the masking sound, both of which are changed in accordance with the time to start recording medium supply;

FIG. 5 is a graph showing a second example of controlling the sound pressure level of a masking sound for the operation of an image forming apparatus; and

FIG. 6 is a graph showing a third example of controlling the sound pressure level of a masking sound for the operation of an image forming apparatus.

### DETAILED DESCRIPTION OF THE PREFERRED EMBODIMENTS

### Regarding Image Forming Apparatus

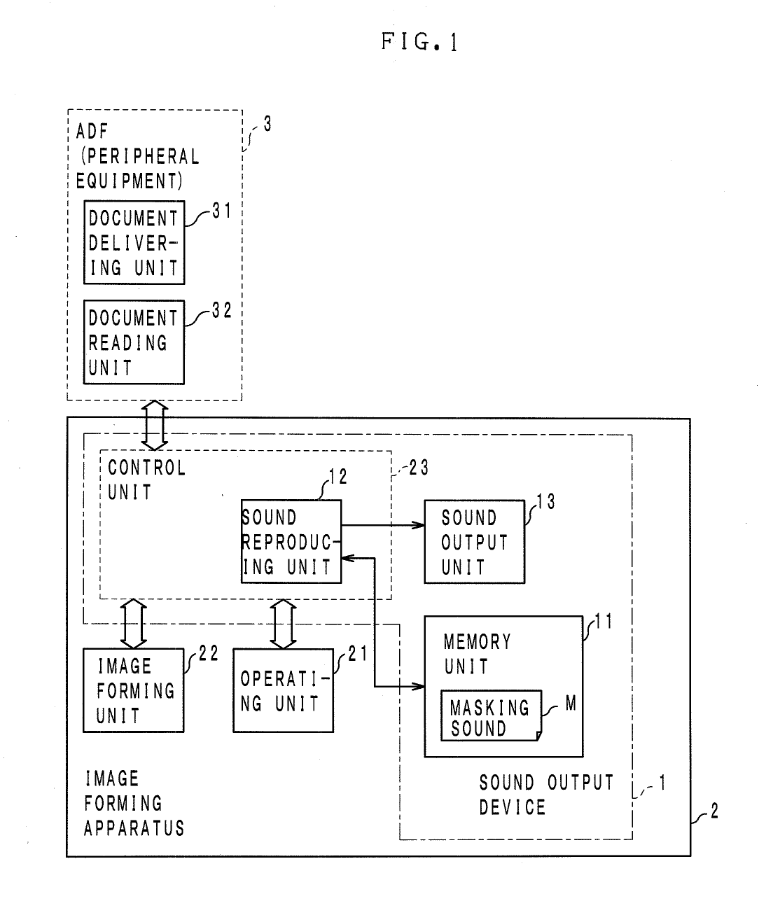

Before describing a sound output device according to an embodiment of the present invention, an image forming apparatus 2 will be described as an example of the equipment in which the sound output device is provided. In FIG. 1, the image forming apparatus 2 is, for example, a multifunction peripheral, color printer, or suchlike, employing electrophotography with a tandem system, and generally includes an operating unit 21, an image forming unit 22, and a control unit 23.

The operating unit 21 is typically provided on the upper front of the image forming apparatus 2, and includes operating buttons to be pressed by the user. A typical exemplary operating button or suchlike is a print start button for the user to instruct the image forming apparatus 2 to start printing. The operating unit 21 transmits a print start command to the control unit 23 in accordance with the user's operation.

In the image forming unit 22, a circumferential surface of a photoreceptor drum is charged by a charger, and thereafter irradiated by an optical system with an optical beam modulated with image data. As a result, an electrostatic latent image is formed on the circumferential surface of the photoreceptor drum. Here, the image data is transmitted from, for example, a document reading unit 32 (to be described later) or a personal computer (not shown) connected to the image forming apparatus 2. Moreover, in the image forming unit 22, a developer supplies toner to the circumferential surface of the photoreceptor drum on which the electrostatic latent image is formed, thereby creating a toner image on the circumferential surface of the photoreceptor drum. In the image forming unit 22, a primary-transfer roller transfers the toner image on the circumferential surface of the photoreceptor drum to a transfer belt. The toner image is created for each of the colors of, for example, yellow (Y), magenta (M), cyan (C), and black (K). Such toner images are transferred onto one another on the transfer belt, so that a combined toner image is supported.

Furthermore, the image forming unit 22 receives a recording medium (e.g., paper) delivered from a supply tray (not shown). In the image forming unit 22, a secondary-transfer roller transfers the combined toner image on the transfer belt to the delivered recording medium. A fusing device heats and presses the recording medium fed from the secondary-transfer roller, thereby fixing the combined toner image onto the recording medium. The recording medium subjected to the fixing process is ejected and placed onto an output tray via an ejection roller of the image forming apparatus 2.

The control unit 23 includes a CPU and main memory, and operates in accordance with a program stored in the main memory, thereby controlling the operation of components of the image forming unit 22 and peripheral equipment. In a specific example, the control unit 23 provides control signals to, for example, motors (not shown) for driving the components of the image forming unit 22.

### Regarding Peripheral Equipment of Image Forming Apparatus

Next, the peripheral equipment of the image forming apparatus 2 will be described. In the present embodiment, an automatic document feeder (ADF) 3 is described as an example of the peripheral equipment. The ADF 3 is provided on the image forming apparatus 2, and generally includes a document delivering unit 31 and a document reading unit 32. Under control of the control unit 23, the document delivering unit 31 delivers an image document placed on a tray of the ADF 3 to the document reading unit 32. The document reading unit 32 is an optical scanner, which reads the image document fed from the document delivering unit 31, generates image data represented by the three primary colors red (R), green (G), and blue (B), and transmits the data to the control unit 23 in the image forming apparatus 2. This RGB image data is converted by the control unit 23 into YMCK image data.

### Embodiment

Next, a sound output device 1 according to an embodiment of the present invention will be described. The sound output device 1 is provided in the image forming apparatus 2, and includes a memory unit 11, a sound reproducing unit 12 incorporated in the control unit 23 in the form of, for example, software, and a sound output unit 13. Note that in the present embodiment, the sound output device 1 is described as being provided in the image forming apparatus 2, which is a printer, a copier, a fax machine, or a device incorporating such functions. However, this is not restrictive, and the sound output device 1 can be provided in any equipment that generates an operation sound.

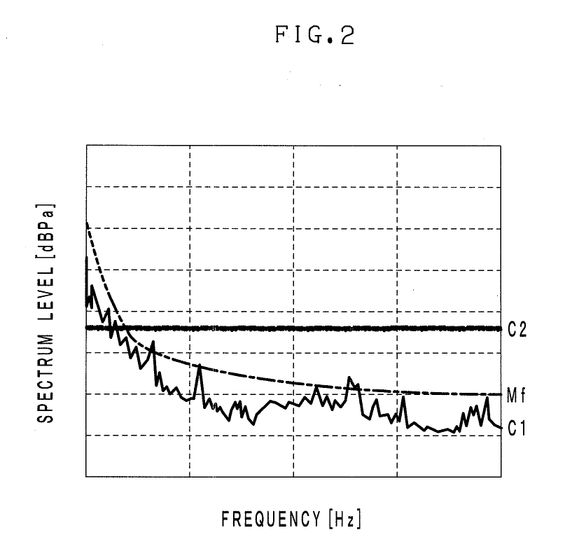

The memory unit 11 is composed of, for example, flash memory, and has stored therein data representing at least one masking sound M. The masking sound M masks an operation sound (noise) generated through a sequential operation of the image forming apparatus 2. Moreover, the masking sound M is a sound obtained by, for example, processing the frequency of an environmental sound or pink noise so as to have a frequency characteristic resembling that of the operation sound. Such a masking sound M is a sound that cannot be recognized by the user as machine noise and is incoherent to the user. Although the basic concept of masking is well known, it will be described in detail below with reference to FIG. 2, taking as an example the operation sound of the image forming apparatus 2.

In FIG. 2, the horizontal axis represents the frequency [Hz], and the vertical axis represents the spectrum level [dBPa]. The spectrum level is a sound pressure level for its corresponding frequency where frequency components of a sound are represented as a spectral distribution. Curve C1 indicates a frequency characteristic of an operation sound (noise), for example, from the start of recording medium supply to the end of printing. Further, curve C2 indicates a frequency characteristic of so-called white noise whose spectrum level is approximately constant regardless of the frequency. Furthermore, curve Mf indicates a frequency characteristic of a masking sound for the operation sound indicated by curve C1.

When an operation sound is superimposed with white noise, the sound leaves harshness in the ears of an observer, and in the case where the operation sound is superimposed with a masking sound, such harshness can be significantly reduced. The masking sound can produce a masking effect if it has a higher spectrum level (sound pressure level) than the operation sound to some degree, as shown in FIG. 2.

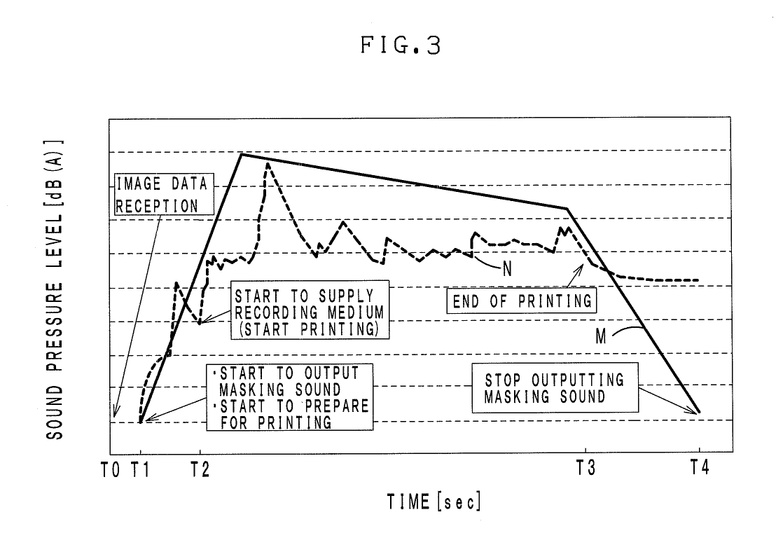

Hereinafter, referring to FIG. 3, a masking sound M reproduced by the sound reproducing unit 12 and outputted by the sound output unit 13 will be described with respect to an example of its changes over time.

First, curve N indicates changes of an operation sound (noise) over time while the image forming apparatus 2 prints a sheet. The control unit 23 receives image data for printing from the document reading unit 32 or an unillustrated personal computer, as described earlier. Hereinbelow, the time of image data reception is indicated by time T0. After the image data is received, the control unit 23 performs preparations for printing, including warm-up of the image forming apparatus 2, from time T1 to time T2. During the warm-up, the sound pressure level of the operation sound is relatively low. From time T2, recording medium supply starts under control of the control unit 23, and after that, a series of printing processing tasks, including recording medium supply, image formation, and recording medium ejection, are performed until time T3, so that the sound pressure level of the operation sound rises. Moreover, the sound pressure level of the operation sound burstly rises due to collision noise occasionally produced by a recording medium being delivered. After time T3, since the printing processing has already ended, the sound pressure level of the operation sound is relatively low.

The operation sound is substantially the same before and after the image forming apparatus 2 is delivered to and actually operated by the user. Therefore, the operation sound is obtained through experiments by the supplier (manufacturer) before the image forming apparatus 2 is operated by the user, and on the basis of the obtained operation sound, the masking sound M is created and stored in the memory unit 11. Hereinbelow, reproduction control of the masking sound M by the sound reproducing unit 12 will be described in detail.

When printing a sheet, the sound reproducing unit 12 reproduces the masking sound M being read from the memory unit 11, and starts outputting the sound from the sound output unit (speaker) 13 at time T1. Here, the output sound pressure level is adjusted so as to be a prescribed initial level at time T1 in a predetermined position around the image forming apparatus 2. This initial level is set at a relatively low sound pressure level.

The output sound pressure level of the masking sound M is adjusted so as to gradually rise after time T1. In addition, the output sound pressure level is adjusted so as to reach a standard value in the predetermined position at time T2. Here, the standard value is set to a sound pressure level greater than both the sound pressure level of the operation sound and the aforementioned initial level. The output sound pressure level of the masking sound M is adjusted to be greater than the sound pressure level of the operation sound thereafter until time T3. In the present embodiment, by way of preferred example, the masking sound M is pre-created so as to mask the operation sound being produced by printing processing performed by the image forming apparatus 2 in the period from time T2 to time T3. In other words, the masking sound M does not mask the operation sound being produced during operation (e.g., during standby and warm-up) before recording medium supply. The reason for this is that the operation sound is relatively low before recording medium supply.

The output sound pressure level of the masking sound M is adjusted so as to gradually fall after time T3, and output of the masking sound stops at time T4.

### Actions and Effects of Embodiment

As described above, in the embodiment of the present invention, the memory unit 11 has the pre-created masking sound M stored therein. After the image forming apparatus 2 receives image data but before it starts printing processing, the sound reproducing unit 12 reads and reproduces the masking sound M from the memory unit 11 and causes the sound output unit 13 to output the reproduced sound. In this manner, the masking sound M is outputted prior to the printing processing by the image forming apparatus 2, and therefore the user's attention is drawn by the masking sound M being outputted first. Therefore, the user's attention tends to not be directed toward the operation sound to be outputted thereafter. Thus, it is possible to provide the sound output device 1 that better achieves a masking effect.

Further, while the masking sound M masks the operation sound (noise) produced at a high sound pressure level during a predetermined action, i.e., printing processing, by the image forming apparatus 2, output of the masking sound M starts before the printing processing. Thus, the user can be prevented from suddenly hearing both loud noise and the masking sound M.

Further still, if the output sound pressure level of the masking sound M suddenly rises immediately after output of the masking sound M starts, the user perceives it to be annoying. Accordingly, in the present embodiment, the masking sound M is controlled to gradually increase in output sound pressure level after its output starts. Thus, the user can perceive the masking sound to be less annoying.

### First Modification

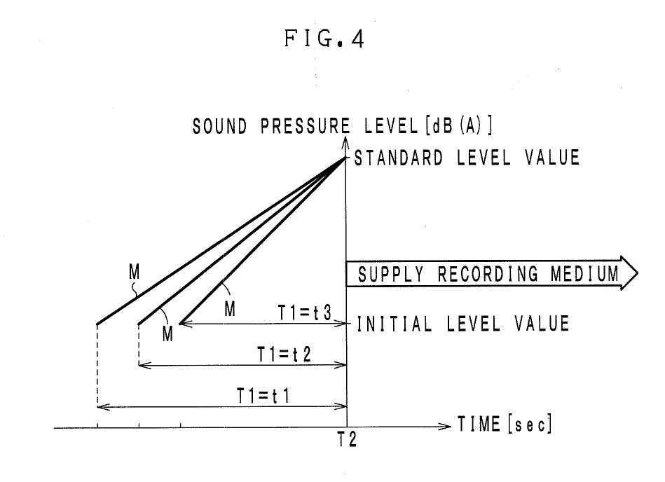

Incidentally, the image forming apparatus 2 can idle in a plurality of modes, including sleep mode, power saving mode, standby mode, etc. The time (T2−T1) from image data reception until the start of recording medium supply varies among the idling modes. To change the output sound pressure level of the masking sound M from the initial value to the standard value in the period from time T1 to time T2, the sound reproducing unit 12 preferably changes the timing of outputting the masking sound M, in accordance with the idling mode at the time of image data reception. For example, upon reception of image data in sleep mode, the sound reproducing unit 12 starts outputting the masking sound M some seconds t1 before time T2, as shown in FIG. 4. Moreover, in the case of power saving mode or standby mode, the sound reproducing unit 12 starts outputting the masking sound M some seconds t2 or t3 before time T2. Here, in the present embodiment, t1, t2, and t3 satisfy t1>t2>t3.

In this manner, in the present modification, the timing of starting output of the masking sound M is controlled on the basis of a period of time from the image forming apparatus 2 starting operation until the start of printing processing. It is also possible to control the degree of change in the output sound pressure level of the masking sound M per unit time. As a result, for each idling mode, the masking sound M can be outputted at a suitable time or at a suitable degree of change in the output sound pressure level, thereby allowing the user to perceive the masking sound M to be less annoying. Moreover, it is desirable for the output sound pressure level of the masking sound M to rise gradually, and therefore the timing of starting output of the masking sound M is preferably advanced in accordance with a period of time up to the start of printing processing, thereby minimizing as much as possible the degree of change in the output sound pressure level of the masking sound M per unit time.

### Second Modification

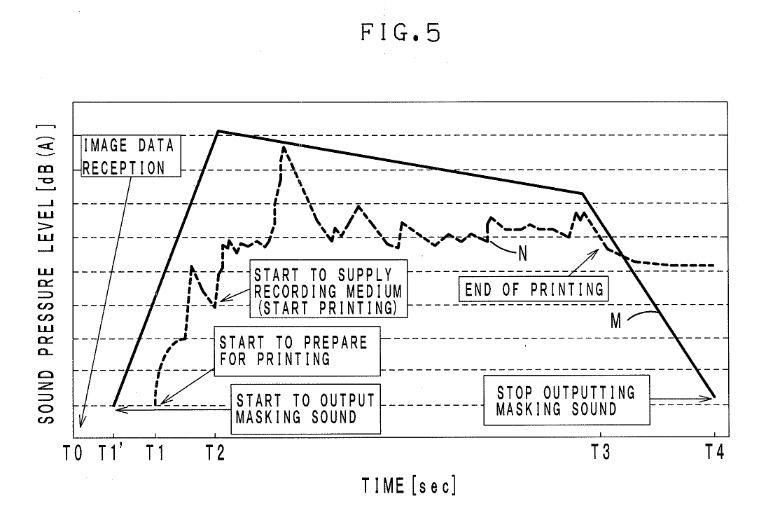

In the first modification, the timing of starting output of the masking sound M and the degree of change in the output sound pressure level of the masking sound M per unit time are adjusted for each of the idling modes. However, this is not restrictive, and, for example, the timing of starting output of the masking sound M may be fixed for any of the idling modes, as shown in FIG. 5. For example, in the example of FIG. 5, image data is received at time T0, and output of the masking sound M starts 0.2 seconds later at time T1′. For example, the sound pressure level of the masking sound M is adjusted so as to reach the standard value at time T2, 1.5 seconds after time T1′. In this case, for each idling mode, the control unit 23 adjusts the timing of starting preparations for printing and the timing of starting recording medium supply, such that a masking effect can be produced at time T2 regardless of the idling mode. The image forming apparatus 2 adopts such a mode in which the timing of starting output of the masking sound M is fixed, and the mode is executed on the basis of user settings.

### Third Modification

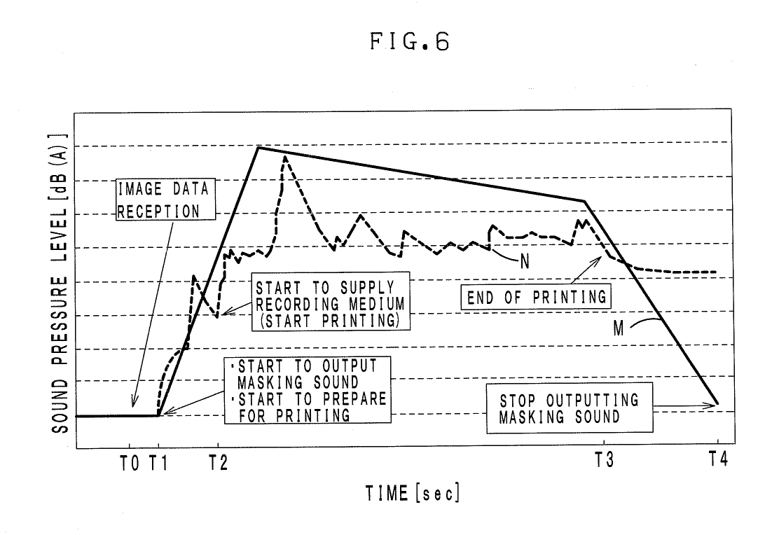

In the foregoing, the masking sound M is outputted after image data reception. However, this is not restrictive, and the sound reproducing unit 12 may cause the sound output unit 13 to start constantly outputting the masking sound M before image data reception (e.g., during the idling mode), as shown in FIG. 6. The output sound pressure level of the masking sound M is controlled to be approximately at the initial level until image data reception. After image data reception, the masking sound M starts to be effectively outputted at time T1, and the sound pressure level thereof is controlled to gradually rise thereafter and reach the standard value at time T2.

Note that the masking sound M has been described above as masking the operation sound of the image forming apparatus 2. However, this is not restrictive, and the masking sound M may mask the operation sounds of the image forming apparatus 2 and its peripheral equipment, the ADF 3.

Although the present invention has been described in connection with the preferred embodiment above, it is to be noted that various changes and modifications are possible to those who are skilled in the art. Such changes and modifications are to be understood as being within the scope of the invention.

What is claimed is:

1. A sound output device for masking an operation sound generated by equipment, comprising:
a sound reproducing unit that starts reproducing a masking sound before the operation sound is generated; and
a sound output unit that outputs the masking sound reproduced by the sound reproducing unit.

2. The sound output device according to claim 1, wherein after output of the masking sound starts, the sound reproducing unit gradually raises an output sound pressure level of the masking sound.

3. The sound output device according to claim 1, wherein,
the masking sound is pre-created so as to mask an operation sound generated during a predetermined action of the equipment, and
the sound reproducing unit controls the timing of starting output of the masking sound and the degree of change in output volume of the masking sound, on the basis of a period of time from the equipment starting operation until the predetermined action is performed.

4. The sound output device according to claim 1, wherein,
the masking sound is pre-created so as to mask an operation sound generated during a predetermined action of the equipment, and
the equipment performs the predetermined action after a lapse of a predetermined period of time once output of the masking sound starts.

5. The sound output device according to claim 1, wherein,
the masking sound is pre-created so as to mask an operation sound generated during a predetermined action of the equipment,
the sound reproducing unit constantly reproduces the masking sound at a relatively low sound pressure level, and
when the equipment starts operating, the sound reproducing unit reproduces the masking sound with the sound pressure level raised to a relatively high value before the predetermined action.

6. The sound output device according to claim 1, wherein the equipment is an image forming apparatus.
